(19) United States
(12) Patent Application Publication
(10) Pub. No.: US 2007/0261929 A1
(43) Pub. Date: Nov. 15, 2007

(54) Aerodynamic vented rotor

(75) Inventors: Frank Hsu, Novi, MI (US); Chris Oakwood, West Bloomfield, MI (US)

Correspondence Address: FORD GLOBAL TECHNOLOGIES;c/o MOFO NOVA, 1650 TYSONS BLVD., SUITE 300, MCLEAN, VA, 22102, US

(73) Assignee: Ford Global Technologies, LLC, Dearborn, MI (US)

(21) Appl. No.: 11/431,632

(22) Filed: May 11, 2006

(51) Int. Cl. F16D 65/827

(52) U.S. Cl. 188/264 R

(57) ABSTRACT

An aerodynamic vented rotor comprises an outboard disc, an inboard disc spaced from the outboard disc, and fins extending between the outboard disc and the inboard disc and defining vents therebetween. The fins have an airfoil-shaped cross section with a leading edge facing radially inwardly on the rotor. The fins constitute an inner core, and a hat section extends from the inner core of the rotor.

### BACKGROUND OF THE INVENTION

1. Field of Invention

This invention relates to the field of vented disc rotors. More specifically, this invention relates to a vented disc rotor having airfoil-shaped fins and/or an anti-coning center core.

2. Background

Many braking systems include a rotor attached to one or more of the vehicle wheels for rotation therewith, and a caliper assembly secured to a non-rotating component of the vehicle, such as the vehicle frame. A typical rotor includes an annular peripheral section having frictional surfaces disposed on opposite sides and a central hub or hat section having fasteners for securing the wheel thereto. The caliper assembly typically includes a pair of brake pads disposed adjacent to the rotor friction surfaces, and a movable piston operatively connected to one or more of the brake pads. When the driver brakes the vehicle, hydraulic, electric, or pneumatic forces move the piston, which clamps the pads against the friction surfaces of the rotating rotor. As the brake pads press against the moving rotor friction surfaces, frictional forces are created that oppose rotation of the wheel and slow or stop the vehicle.

The frictional braking forces generate heat that is absorbed by the rotor, increasing the temperature of the rotor, causing thermal expansion/distortion, temperature variation across the face of the rotor, and heat transfer to the adjacent components. When the rotor is fixed with respect to the wheel hub, thermal expansion of the rotor is limited because of the integral connection between the rotor and the hub. This creates thermal “coning” in the rotor surface and a large thermal gradient, which can induce high thermal stress leading to thermal cracking, and other undesirable non-uniform loading of components.

Therefore, it is important to dissipate the heat and cool the rotor, because excessive rotor temperatures reduce braking performance, creating longer stopping distances, shorten the life of the rotor and/or the friction pads, or even cause braking failure. Rotors are commonly cooled using moving air that absorbs heat from the rotor and carries it away. It is known to “ventilate” rotors by forming holes or vents through the friction surfaces or the hat section of the rotor. As the rotor turns, air is moved through the vents. The moving air absorbs heat and cools the rotor. Cooling the rotor can also prevent rotor coning.

### BRIEF SUMMARY OF THE INVENTION

Vented brake rotors are commonly used to improve heat transfer for cooling automotive brakes. Vent efficiency in transferring heat is determined by several factors, including the number of fins, fin location, fin size, and the cross-sectional profile of the fins. Conventional vent geometry often includes straight lines and arcs, which undesirably cause flow separation when air flows through vents.

Another aspect of heat transfer for automotive brakes is minimizing uneven thermal distortion of the rotor plates encompassing the vent. Uneven distortion, often referred to as “coning,” causes uneven wear of brake pads and rotors, and subsequently sub-optimized brake performance. In conventional rotors, the central hub or hat section is connected to either the rotor's outboard disc or its inboard disc. Whichever disc the hat section extends from is cooled more effectively because the friction heat generated in the disc is transferred through the hat section in addition to being cooled by the rotor vents. The other disc is, for the most part cooled only by the vents. Because one disc is cooled more effectively, the discs have an uneven heat distribution and therefore uneven thermal distortion from heat, resulting in coning.

The present invention provides two design features for improving disc brake heat transfer. First, using an airfoil shape for the rotor fins to reduce flow separation and increase convective heat transfer efficiency. The airfoil shape is preferably a NACA airfoil series shape, as is known generally but has not been applied in brake rotor designs. Airfoil shapes can also be used for other surfaces of the rotor to further reduce flow separation. Second, the central hub or hat section of the rotor connects to the rotor's inner core, preferably at a point midway between the inboard disc and the outboard disc. As a result, thermal expansion of the rotor plates is no longer uneven because both discs have the same cooling path as heat is transferred to be cooled by the vents and then through a more centrally-located hat region. The inner core commonly refers to the rotor structure that is located between the inner surfaces of the two braking plates, and includes the fins in the present invention.

CAE/CFD analysis shows that air passing through the aerodynamic rotor of the present invention can be 2.6 times higher than rotors that do not have vented disc rotors with airfoil-shaped fins, and the average heat transfer coefficient can be 1.15 times higher at a speed of 33 mph. This additional capability to dissipate heat from the rotor will significantly improve rotor cooling and brake performance.

In one embodiment, the invention is directed to an aerodynamic vented rotor comprising an outboard disc, an inboard disc spaced from the outboard disc, and fins extending between the outboard disc and the inboard disc and defining vents therebetween. The fins have an airfoil-shaped cross section with a leading edge facing radially inwardly on the rotor.

In another embodiment, the invention is directed to a method of manufacturing an aerodynamic vented rotor. The method comprises forming a rotor having an outboard disc, an inboard disc spaced from the outboard disc, and fins extending between the outboard disc and the inboard disc that define vents therebetween, the fins having an airfoil-shaped cross section with a leading edge facing radially inwardly on the rotor.

In another embodiment, the invention is directed to a method for cooling a vented rotor. The method comprises providing a rotor having an outboard disc and an inboard disc spaced from the outboard disc, and providing fins that extend between the outboard disc and the inboard disc and define vents therebetween. The fins have an airfoil-shaped cross section with a leading edge facing radially inwardly on the rotor.

In another embodiment, the invention is directed to an aerodynamic vented rotor comprising an outboard disc and an inboard disc that are spaced from each other, fins extending between the outboard disc and the inboard disc, the fins constituting an inner core, and a hat section extending from the inner core of the rotor.

In another embodiment, the invention is directed to a method of manufacturing an aerodynamic vented rotor. The method comprises forming a rotor having an outboard disc, an inboard disc spaced from the outboard disc, and fins extending between the outboard disc and the inboard disc. The fins constitute an inner core and a hat section extends from the inner core.

In yet another embodiment, the invention is directed to a method for cooling a vented rotor. The method comprises providing an outboard disc and an inboard disc that are spaced from each other, providing fins extending between the outboard disc and the inboard disc, the fins constituting an inner core, and providing a hat section extending from the inner core.

Further features of the present invention, as well as the structure of various embodiments of the present invention are described in detail below with reference to the accompanying drawings.

### BRIEF DESCRIPTION OF THE DRAWINGS

The accompanying drawings, which are incorporated herein and form part of the specification, illustrate the present invention and together with the description, further serve to explain the principles of the invention and to enable a person skilled in the pertinent art to make and use the invention. In the drawings, like reference numbers indicate identical or functionally similar elements.

FIG. 1 is a side view of an embodiment of the aerodynamic vented rotor of the invention.

FIG. 1A is a cross-sectional view of the rotor of FIG. 1, taken along line A-A in FIG. 1.

FIG. 2 is a perspective view of the aerodynamic vented rotor of the invention.

FIG. 2A illustrates a wedge-shaped cutout of the rotor of FIG. 2, taken along lines A-A and B-B of FIG. 2.

FIGS. 3A through 3C illustrate an exemplary airflow in an embodiment of the aerodynamic vented rotor of the invention.

### DETAILED DESCRIPTION OF THE INVENTION

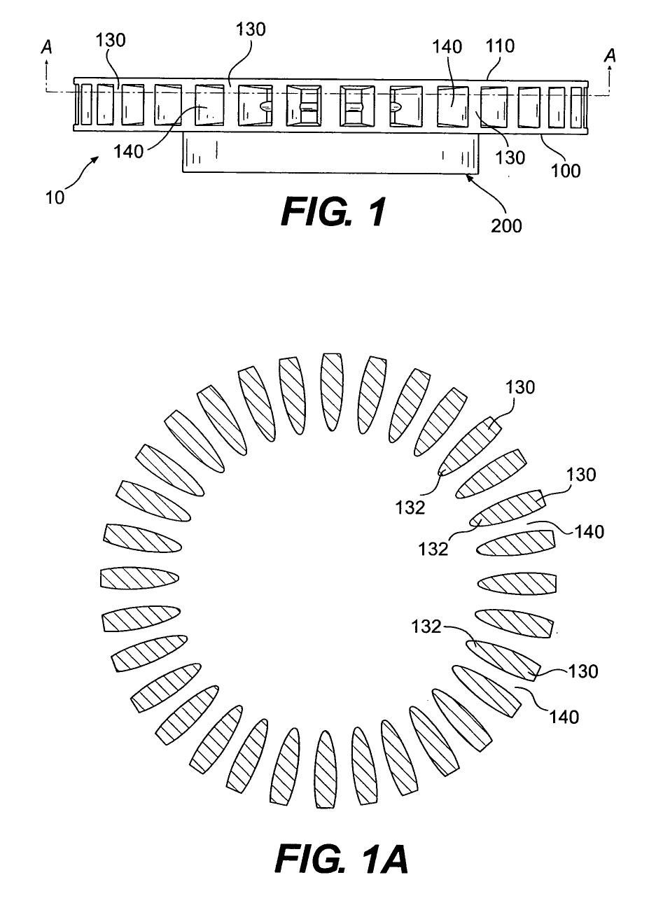

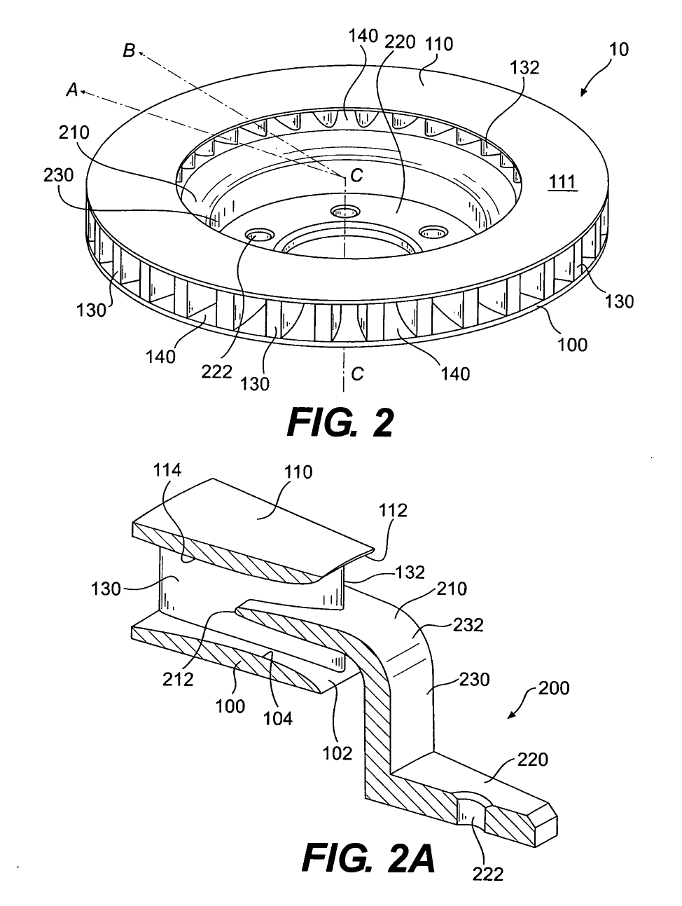

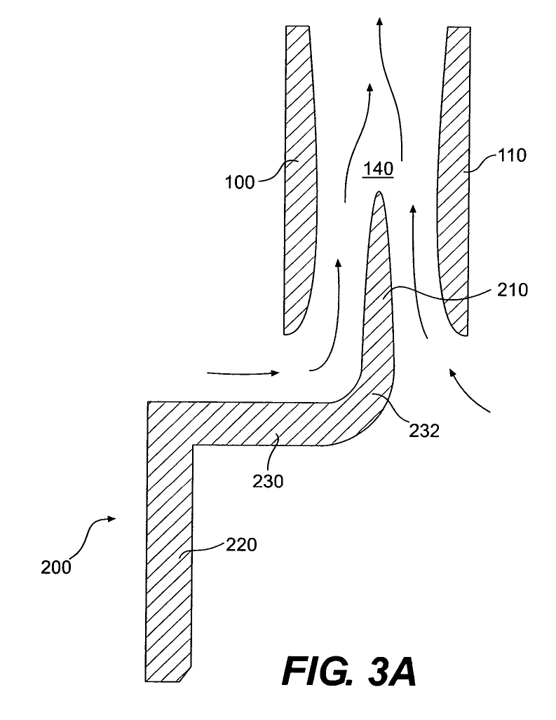

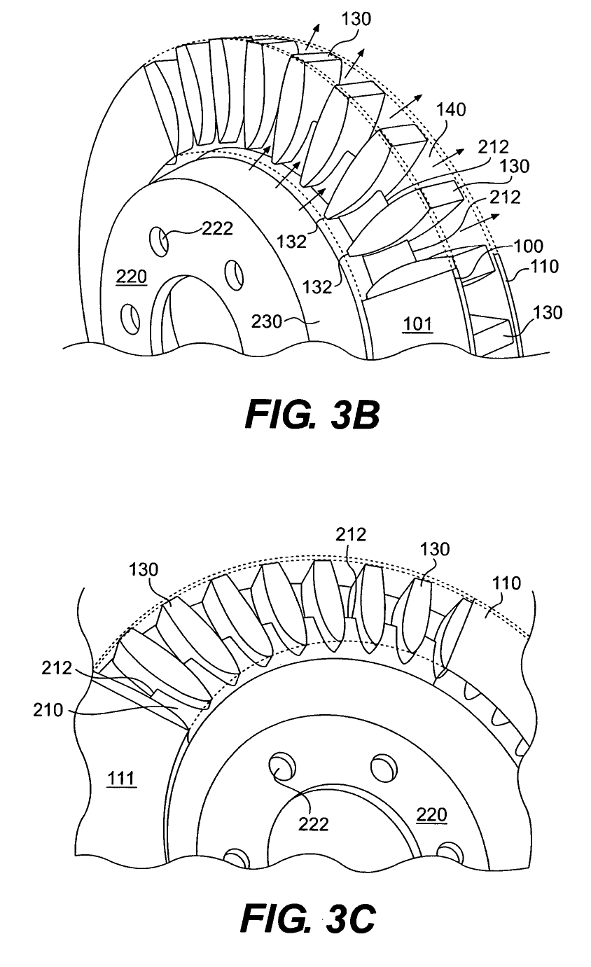

As shown in FIG. 1, an aerodynamic vented rotor 10 of the invention includes an outboard disc 100 and an inboard disc 110. The outboard disc 100 and the inboard disc 110 are preferably parallel annular discs that are spaced from one another. Outboard disc 100 is what a user might see from a location external to (outside of) the vehicle when looking into the vehicle's wheel. The outboard disc 100 includes a friction surface 101 (see FIG. 3B) and the inboard disc 110 includes a friction surface 111 (see FIGS. 2 and 3C). The friction surfaces 101, 111 are preferably maintained adjacent to brake pads of a brake caliper (not shown). During braking, brake pads commonly sweep along the friction surfaces 101, 111 to slow or stop the vehicle through controlled slippage. Thus, friction surfaces 101, 111 are heat dissipating surfaces during vehicle braking.

The outboard disc 100 and the inboard disc 110 are spaced from one another by vanes or fins 130. Vents 140 extend between the fins 130 and between the outboard plate 100 and the inboard plate 110. Vents 140 preferably are distributed circumferentially between the outboard disc 100 and the inboard disc 110 so that, as the rotor 10 turns during vehicle use, the fins 130 induce air flow from the radial interior of the rotor 10, through the vents 140, and out to the radial exterior of the rotor. Air passing through the vents 140 draws heat from the rotor 10 and expels it radially outwardly to cool the rotor 10 via convection. The path of air flow through a rotor 10 of the present invention will be discussed in more detail below with reference to FIGS. 3A-3C.

As best illustrated in FIG. 1A, the fins 130 of the present invention have an airfoil shape. The leading edges 132 of the airfoil-shaped fins 130 face radially inwardly on the rotor 10 and maintain laminar flow of air passing by the fins 130 to delay transition to turbulent flow over the length of the fins 130. Delaying transition to turbulent flow decreases turbulence and minimizes the boundary layer around each fin 130. This, in turn, minimizes air flow separation. Because air flow separation decreases overall airflow around the fins 130 and through the vents 140, minimizing air flow separation increases air flow through the vents 140 of the rotor 10 for improved cooling of the rotor 10. The fins 130 of the rotor 10 make up an inner core of the rotor 10.

As shown in FIGS. 2 and 2A, in a particularly preferred embodiment of the invention, central hub or hat section 200 extends from the inner core of the rotor 10. The hat section 200 comprises a connecting portion 210 that connects the hat portion 200 to the inner core of the rotor 10. Although in conventional rotors the hat section extends from the inner diameter of the outboard disc, FIG. 2A illustrates the hat section 200 of the present invention extending from the inner core rather than the outboard disc 100. In fact, as illustrated, the hat section 200 preferably extends from the inner core of the rotor 10 at a point midway between the outboard disc 100 and the inboard disc 110. The hat section 200 includes a mounting portion 220 having mounting holes 222 for mounting the rotor to a vehicle's wheel hub (not shown).

The mounting portion 220 is connected to the connecting portion 210 via a central portion 230 of the hat section 200. In a preferred embodiment of the invention, a rounded corner 232 joins the central portion 230 to the connecting portion 210. The rounded corner 232 helps to efficiently direct air flow to the vents 140 of the rotor 10, by avoiding air flow separation that could occur at a sharp corner.

As shown in FIG. 2A, the connecting portion 210 of the hat section 200 preferably tapers in thickness along the inner core to a portion 212 that is rounded and shaped as an airfoil leading edge. The rounded portion 212 reduces turbulence and airflow separation within the vets 140 of the rotor 120 to increase airflow through the vents 140, thereby increasing rotor cooling.

In a particularly preferred embodiment of the invention, the radially inward edge 102 of the outboard disc 100 has an airfoil shape or is shaped, as shown in FIG. 2A, to have an airfoil-shaped leading edge on its inner surface 104. The outer friction surface 101 of the outboard disc 100 preferably remains flat. Like the leading edges 132 of the fins 130, the leading edge 102 of the rotor's outboard disc 100 helps to maintain laminar flow of air passing along at least the inner surface 104 of the outboard disc 100 to delay transition of air to turbulent flow over the length of the inner surface 104. Delaying transition to turbulent flow decreases turbulence and minimizes the boundary layer along the inner surface 104, which minimizes air flow separation. Because air flow separation decreases overall airflow along the inner surface 104 and through the vents 140, minimizing air flow separation increases air flow through the vents 140 for improved cooling of the rotor 10. Similarly, the radially inward edge 112 of the inboard disc 110 preferably has an airfoil shape or is shaped, as shown in FIG. 2A, to have an airfoil-shaped leading edge on its inner surface 114. The friction surface 111 of the inboard disc 110 preferably remains flat.

Rotor 10 may be constructed, for example, from an iron, aluminum, or metal matrix composition through known methods such as casting. It is preferably cast as a single piece. While the invention is described above with respect to rotors for automotive braking applications, the principles of the inventions can be applied, and are contemplated for application, to other devices employing rotors, including airplanes.

It is known that the rate of convective heat transfer from a ventilated brake rotor is directly related to the velocity of air flowing through the rotor's vents. To optimize the velocity of air flowing through the rotor's vents, the present invention induces a maximum air flow over the expected operating speeds of the rotor 10. For an automobile, the expected operating speeds of a rotor may range form twenty mph to seventy mph. For airplanes and high performance racecars, expected operating speeds of the rotor are much higher.

FIGS. 3A-3C illustrate the flow of air through a rotor 10 during vehicle use. FIG. 3A illustrates air flow from a view taken along line A-A of FIG. 2, and shows air flow through the rotor 10 from both the inboard and outboard sides of the rotor. FIG. 3B illustrates air flowing through the rotor 10 as seen from the outboard side of the rotor. FIG. 3C illustrates air flowing through the rotor 10 as seen from the inboard side of the rotor.

Air flows into the rotor 10 from the radially inner portion of the rotor 10, along and around the hat section 200. Air enters the vents 140 of the rotor 10 from both the outboard side and the inboard side, and travels through the vents 140 radially outwardly to exit the rotor 10.

What is claimed is:

1. An aerodynamic vented rotor, comprising:
an outboard disc;
an inboard disc spaced from the outboard disc; and
fins extending between the outboard disc and the inboard disc and defining vents therebetween,
wherein the fins have an airfoil-shaped cross section with a leading edge facing radially inwardly on the rotor.

2. The aerodynamic vented rotor of claim 1, wherein the airfoil shape of the fins maintains laminar flow of air passing by the fins in a radially outward direction, and delays transition of air to turbulent flow over the length of the fins.

3. The aerodynamic vented rotor of claim 1, wherein a radially inward edge of the outboard disc has an airfoil-shaped leading edge on its inner surface.

4. The aerodynamic vented rotor of claim 1, wherein a radially inward edge of the inboard disc has an airfoil-shaped leading edge on its inner surface.

5. The aerodynamic vented rotor of claim 1, wherein rotor further includes an inner core comprising the fins, and a hat section having a connecting portion that connects to the inner core and tapers in thickness in a radially outward direction to an airfoil-shaped leading edge.

6. A method of manufacturing an aerodynamic vented rotor, comprising:
forming a rotor having an outboard disc, an inboard disc spaced from the outboard disc, and fins extending between the outboard disc and the inboard disc that define vents therebetween, the fins having an airfoil-shaped cross section with a leading edge facing radially inwardly on the rotor.

7. The method of claim 6, wherein the rotor is formed by casting.

8. The method of claim 6, wherein a radially inward edge of the outboard disc has an airfoil-shaped leading edge on its inner surface.

9. The method of claim 6, wherein a radially inward edge of the inboard disc has an airfoil-shaped leading edge on its inner surface.

10. The method of claim 6, wherein rotor further includes an inner core comprising the fins, and a hat section having a connecting portion that connects to the inner core and tapers in thickness in a radially outward direction to an airfoil-shaped leading edge.

11. A method for cooling a vented rotor, comprising:
providing a rotor having an outboard disc and an inboard disc spaced from the outboard disc; and
providing fins that extend between the outboard disc and the inboard disc and define vents therebetween,
wherein the fins have an airfoil-shaped cross section with a leading edge facing radially inwardly on the rotor.

12. The method of claim 11, wherein the airfoil shape of the fins maintains laminar flow of air passing by the fins in a radially outward direction, and delays transition of air to turbulent flow over the length of the fins.

13. The method of claim 11, wherein a radially inward edge of the outboard disc has an airfoil-shaped leading edge on its inner surface.

14. The method of claim 11, wherein a radially inward edge of the inboard disc has an airfoil-shaped leading edge on its inner surface.

15. The method of claim 11, wherein an inner core comprises the fins, and further comprising providing a hat section for the rotor, the hat section having a connecting portion that connects to the inner core and tapers in thickness in a radially outward direction to an airfoil-shaped leading edge.

16. An aerodynamic vented rotor, comprising:
an outboard disc and an inboard disc that are spaced from each other;
fins extending between the outboard disc and the inboard disc, the fins constituting an inner core; and
a hat section extending from the inner core of the rotor.

17. The aerodynamic vented rotor of claim 16, wherein the hat section extends from the inner core at a point midway between the outboard disc and the inboard disc.

18. The aerodynamic vented rotor of claim 16, the hat section comprising:
a mounting portion for mounting to a wheel hub;
a connecting portion that connects the hat section to the inner core of the rotor; and
a central portion extending between the mounting portion and the connecting portion.

19. The aerodynamic vented rotor of claim 18, wherein the connecting portion tapers in thickness in a radially outward direction to an airfoil-shaped leading edge.

20. A method of manufacturing an aerodynamic vented rotor, comprising:
forming a rotor having an outboard disc, an inboard disc spaced from the outboard disc, and fins extending between the outboard disc and the inboard disc,
wherein the fins constitute an inner core and a hat section extends from the inner core.

21. The method of claim 20, wherein the rotor is formed by casting.

22. The method of claim 20, wherein the hat section extends from the inner core at a point midway between the outboard disc and the inboard disc.

23. The method of claim 20, the hat section comprising:
a mounting portion for mounting to a wheel hub;
a connecting portion that connects the hat section to the inner core; and
a central portion extending between the mounting portion and the connecting portion.

24. The method of claim 23, wherein the connecting portion tapers in thickness in a radially outward direction to an airfoil-shaped leading edge.

25. A method for cooling a vented rotor, comprising:
providing an outboard disc and an inboard disc that are spaced from each other;
providing fins extending between the outboard disc and the inboard disc, the fins constituting an inner core; and
providing a hat section extending from the inner core.

26. The method of claim 25, wherein the hat section extends from the inner core of the rotor at a point midway between the outboard disc and the inboard disc.

27. The method of claim 25, the hat section comprising:
a mounting portion for mounting to a wheel hub;
a connecting portion that connects the hat section to the inner core; and
a central portion extending between the mounting portion and the connecting portion.

28. The method of claim 27, wherein the connecting portion tapers in thickness in a radially outward direction to an airfoil-shaped leading edge.
